(19) United States
(12) Patent Application Publication
(10) Pub. No.: US 2013/0097914 A1
(43) Pub. Date: Apr. 25, 2013

(54) ROLLER GUIDES FOR FISHING ROD

(71) Applicant: Ricky Barber, Anaheim, CA (US)

(72) Inventor: Ricky Barber, Anaheim, CA (US)

(21) Appl. No.: 13/659,815

(22) Filed: Oct. 24, 2012

Related U.S. Application Data
(60) Provisional application No. 61/628,068, filed on Oct. 24, 2011.

(51) Int. Cl. A01K 87/04

(52) U.S. Cl. 43/24

(57) ABSTRACT

A roller guide for fishing rod, the roller guide comprising a frame associated with which are two feet for associating the frame to the fishing rod during installation of the roller guide onto the fishing rod, wherein at least one of the two feet is pivotally associated at one end with the frame, such that when the roller guide is installed onto the fishing rod, the at least one of the two feet pivots with the fishing rod when the fishing rod bends, thus, accommodating the flex of the fishing rod during use.

### CROSS-REFERENCE TO RELATED APPLICATIONS

This application claims the benefit of U.S. Provisional Application No. 61/628,068, filed Oct. 24, 2011, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to fishing rods and more particularly to fishing rod line guides.

2. Description of the Related Art

There are basically two types of fishing rod line guides. The first type is ring guides which are generally used on fishing rods for smaller game fish. The second type is roller guides which are typically used on big game fishing rods used for large fish like marlin, tuna and shark. Roller guides are also used on trolling rods and can also be found on some spin casting and bait casting fishing rods.

Roller guides are frames with feet, placed in line on top of a fishing rod. Typically, the frame contains two small rotating rollers or one rotating and one stationary round guide. There are usually 4 to 6 roller guides bonded to the rod, depending primarily on the length of the fishing rod, in line, along the length of the fishing rod. The fishing line is threaded through each roller guide in between each roller along the length of the rod.

The rollers roll as the line is brought in or taken out along the rod. What this does is reduce the friction between the line and the roller because the roller, rolls as the line moves along the roller, as opposed to a ring guide, where the line drags across the ring.

Large fish can swim 30 MPH or faster for several hundred yards which cause significant amount of heat from friction in a ring guide but very little amount of heat is generated in a roller guide. Thus, the line is better protected by roller guides, and thus, it lasts longer.

A short coming of roller guides is the large size, particularly the toe to toe length which can reach over 3 inches. Rigidity is also a deficiency of existing roller guides. When bonding approximately five guides to a fishing rod, the length of metal from toe to toe imparts rigidity (flat spots) on a rod. These flat spots create week spots on the rod and also dampen the feel and action of the fishing rod.

Another deficiency of the existing rod roller guides is that when they are damaged or seized up due to, for example, salt residue buildup, the rod may be un-repairable, discarded or sent to a rod builder for repair, due to the substantial difficulty of replacing the existing roller guides.

Thus, there is a need for new and improved line roller guides that address the problems described above.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment the legs of the roller guide pivot with the rod as the rod bends which allows the rod to bend more true to form during use. The presence and proper placement of pivots and slides allow the guide construction to accommodate the flex of the rod. Thus, an advantage is that the flexible line guide may be used with greater rate of success on heavy duty fishing rods. Another advantage is that it allows the rod to maintain a smooth bend, and thus, its strength and a smoother, improved feel to the fisherman. Another advantage is that it reduces rod fractures, the number of broken rods, and thus, it saves money. Furthermore, because the roller guide can easily be removed, another advantage is that one of ordinary skill can repair or replace the roller guide in the field, which saves money and will extend the life of the fishing rod.

The above embodiment and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is a side view of a line guide according to one embodiment.

FIG. 2 is a top view of the line guide from FIG. 1.

FIG. 3 is a right side end view of the line guide from FIG. 1.

FIG. 4 is a perspective view of the line guide from FIG. 1.

FIG. 5 is an exploded perspective view of the line guide from FIG. 4.

FIGS. 6-10 show the largest line guide nearest the reel (FIG. 6) to the smallest line guide (FIG. 10) nearest the tip of the rod.

FIG. 11 is a side view of the largest line guide nearest the reel and shows the guide and sock bonded to the rod.

FIG. 12 is a side view of the next largest line guide and shows the guide and sock before bonding to the rod.

FIG. 13 is a side view of the next largest line guide and shows the guide without the sock before bonding to the rod.

FIG. 14 is a side view of a rod with the five line roller guides placed on the rod and the rod is bent as if in use.

FIG. 15 is a side view of the next largest line guide and shows the guide feet bending and sliding inside the sock to accommodate the bending of the rod.

FIG. 16 is a reference side view of a rod with the five line guides placed on the rod and the rod is bent as if in use.

FIG. 17 is a side view of the next largest line guide and shows the line guide position with the rod in a normal relaxed position.

FIG. 18 is a reference side view of a rod with the five line guides placed on the rod and the rod is in a normal relaxed position.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

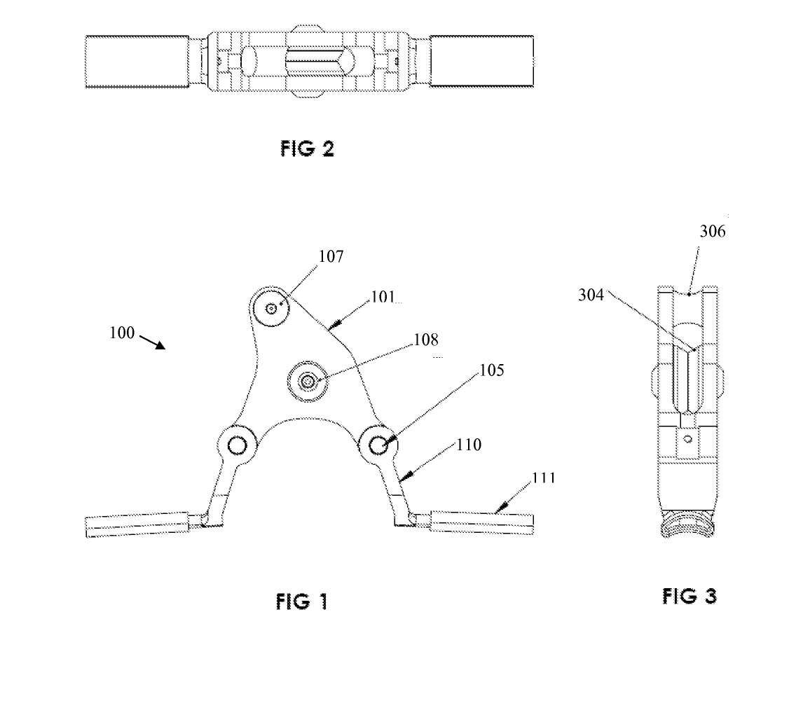

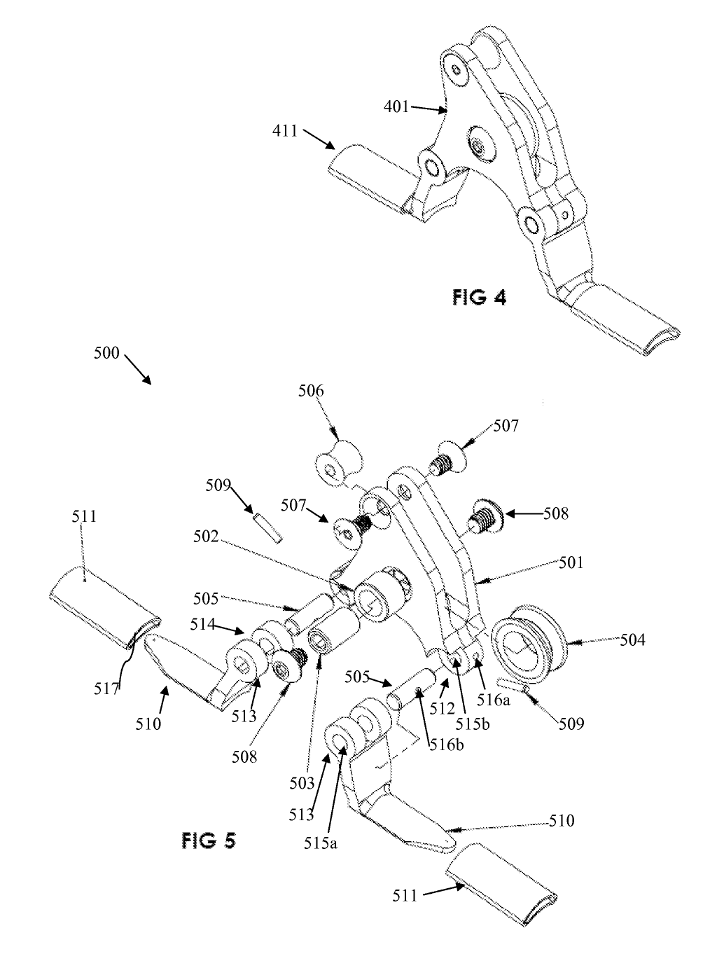

FIG. 1 is a side view of a line guide 100 according to one embodiment. FIG. 2 is a top view, FIG. 3 is a right side end view, and FIG. 4 is a perspective view of the line guide from FIG. 1. The detail description of the various components of the line guide (i.e., guide, line roller guide or roller guide; all terms are synonymous herein) 100 and their role will be better understood in reference to FIG. 5, the description of which is below.

FIG. 5 is an exploded perspective view of the line guide from FIG. 4. This is also an embodiment of a method of assembly of the line roller guide 500. Referring now to the embodiment in more detail, in FIG. 5 there is shown frame 501 (i.e., 101 in FIG. 1; 401 in FIG. 4) and associated with frame 501, as shown, are several components, as follows: top roller 506 (306 in FIG. 3) which is fastened to frame 501, for example, by using two screws 507 (107 in FIG. 1), one on each side of frame 501 such that, typically, rotation of top roller 506 is not permitted; the barrel 503 is inserted into bearing 502, than barrel 503 and bearing 502 together are inserted into bottom roller 504 (304 in FIG. 3) then fastened to frame 501 with, for example, two screws 508 (108 in FIG. 1), one on each side of frame 501, by, preferably, fastening screws 508 into the inner threaded surface of barrel 503; thus, due to use of bearing 502, low friction rotation of the bottom roller 504 is permitted; next, the foot 510 (110 in FIG. 1) and its hinge 513 are aligned to frame receptacle 512, such that frame receptacle 512 fits in middle opening 514 of the hinge 513 and the hinge pin 505 (105 in FIG. 1) may be inserted through hinge aperture 515a and receptacle aperture 515b; next, a dowel pin 509 may be pressed into receptacle hole 516a and through hinge pin hole 516b.

Thus, it should be noted from the above description, that the two feet 510 are pivotally attached to the frame 501. This configuration allows a fishing rod to bend more true to its form during use as it will be explained in more details herein. It should be also noted that one pivotally attached foot may be enough to help here, but two feet, both pivotally attached, is the preferred configuration in order to provide better flexibility to the line roller guide 500.

The use of the two socks 511 (one for each foot 510) are optional. When they are not used, the feet 510 are secured or bonded to the rod. However, the use of socks 511 increases the flexibility of the line roller guide 500 even more, which in turns contributes to the increased ability of the rod to bend more naturally. If used, socks 511 (111 in FIG. 1; 411 in FIG. 4) may be assembled in two variations. In a first preferred variation, two socks 511 are used, each sliding over one foot 510, and both socks 511 are bonded to the fishing rod (see FIG. 11). In a second variation, only one sock 511 is used, sliding over one foot 510, and the only one sock 511 and the other foot 510 (without a sock), are bonded to the rod. It should be noted that the foot 510 is configured to fit into sock cavity 517 such that sliding, in-and-out, of foot 510 is facilitated, preferably with minimum friction between the two components.

Because the line roller guide 500 will typically be subjected to salt water, the materials used in the guide's construction may preferably be rust resistant. In some embodiments, the frame 501 and the legs/feet 510 are coated aluminum, but they may also be made from coated or plated steel, stainless steel, and so on, in order to provide rust protection. The rollers and pins are preferably made from stainless steel, for wear resistant. The bearings are preferably made from low friction plastic or in some embodiments from metal.

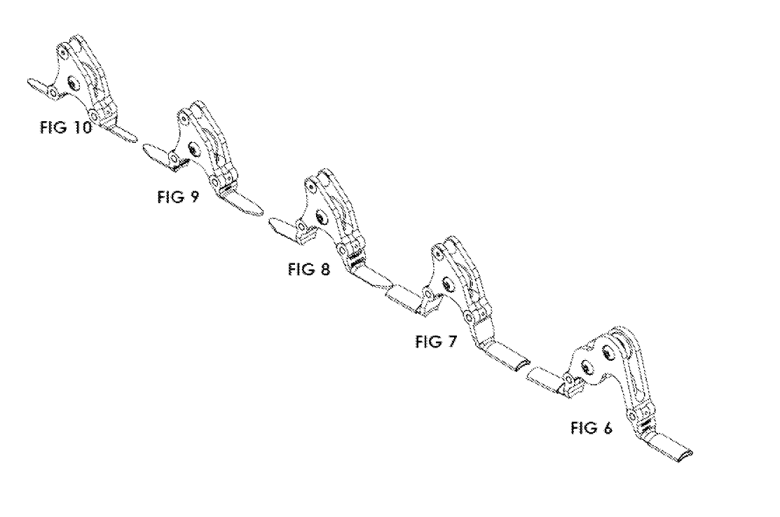

FIGS. 6-10 show the largest line guide nearest the reel (FIG. 6) to the smallest line guide (FIG. 10) nearest the tip of the rod. As one of ordinary skills in the art would recognize, this is a typical installation of roller guides to accommodate the variation in diameter of the rod. Thus, various sizes of roller guides are typically needed to equip a rod.

It should be noted that the first two guides, FIGS. 6-7, have socks, while the other guides do not. This configuration may be preferred on very stiff rods because the greatest bending takes place in this portion of a stiff rod. However, on flexible rods the use of socks on all roller guides is preferable.

FIG. 11 is a side view of the largest line guide 1100 nearest the reel (not shown) and shows the socks 1111 (one on each side) bonded (1130) to the rod 1150. As shown, the preferred method of bonding is to bond the sock 1111 (or the feet if no sock is used) directly to the rod 1150 and not extending the bonding from foot tip to foot tip as it is usually done with existing rods. Again, it should be noted that each foot 1110 slides into its sock 1111, as earlier described.

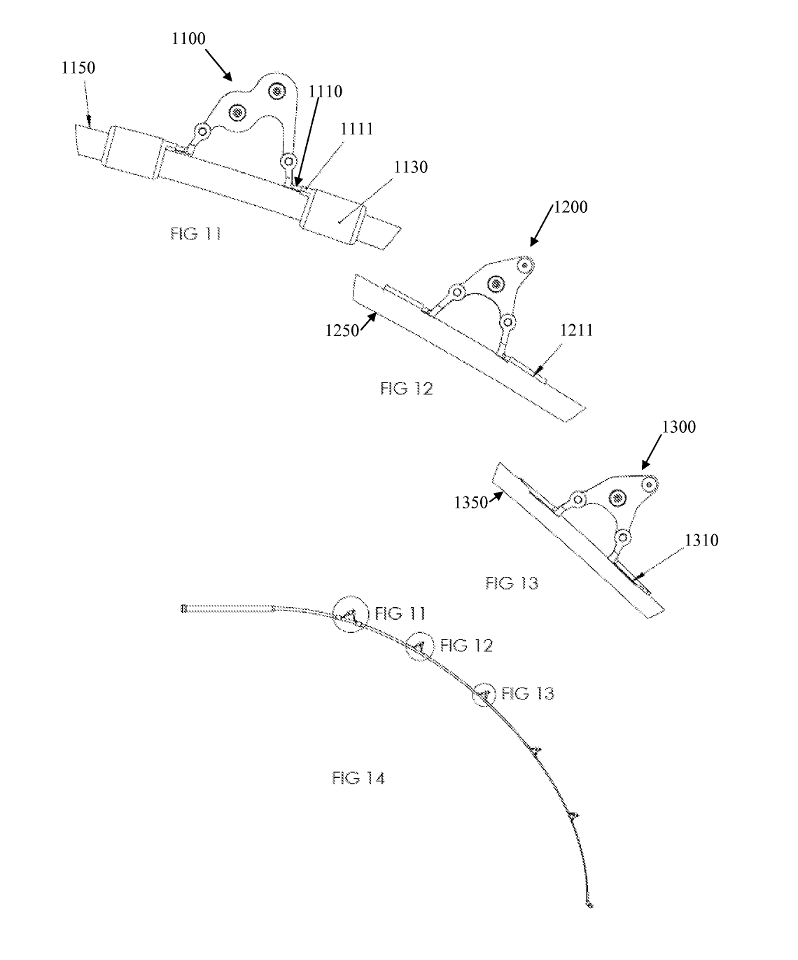

FIG. 12 is a side view of the next largest line guide and shows the guide 1200 and sock 1211 before bonding to the rod 1250. FIG. 13 is a side view of the next largest line guide and shows the guide 1300 without the sock, thus, with the exposed leg 1310, before bonding to the rod 1350. Again, FIG. 14 is a side view of a rod with the five line roller guides placed on the rod and the rod is bent as if in use.

FIG. 15 is a side view of the next largest line guide 1500 and shows the guide feet 1510 pivoting inwards around joint 1570 and sliding out of the socks 1511 to accommodate the natural, true-to-form bending of the rod 1550. It should be noted that the guide 1500 is shown in FIG. 15 without the bonding agent to better view and understand the flexibility of the guide. Again, the pivotal joints 1570 may be constructed, for example, as described earlier when referring to FIG. 5.

It should be noted that the pivotal joints 1570, which connect the feet 1510 to the frame 1501, in combination with the ability of the feet 1510 to slide in-and-out of the socks 1511 make the roller guide 1500 truly flexible, such that the bending of the rod 1550 is natural. It should be noted that the guide 1500 permits the rod 1550 to have a substantially continuous curvature, without any flat sections. Again, the flexibility of the guide 1500 allows the rod 1550 to maintain a smooth bend which allows the rod to maintain its strength and an improved, more pleasant, feel to the fisherman. In addition, the flexible guide reduces rod fractures, and thus, the number of broken rods.

FIG. 16 is a reference side view of a rod with the five line guides placed on the rod and the rod is bent as if in use.

FIG. 17 is a side view of the next largest line guide and shows the line guide 1700 position with the rod 1750 in a normal, relaxed position. It should be noted the angle difference in the feet between FIG. 17 and FIG. 15, namely that in FIG. 17 the feet 1710, enabled by the joints 1770, have slid back into the socks 1711, thus permitting the rod 1750 to regain its straight form.

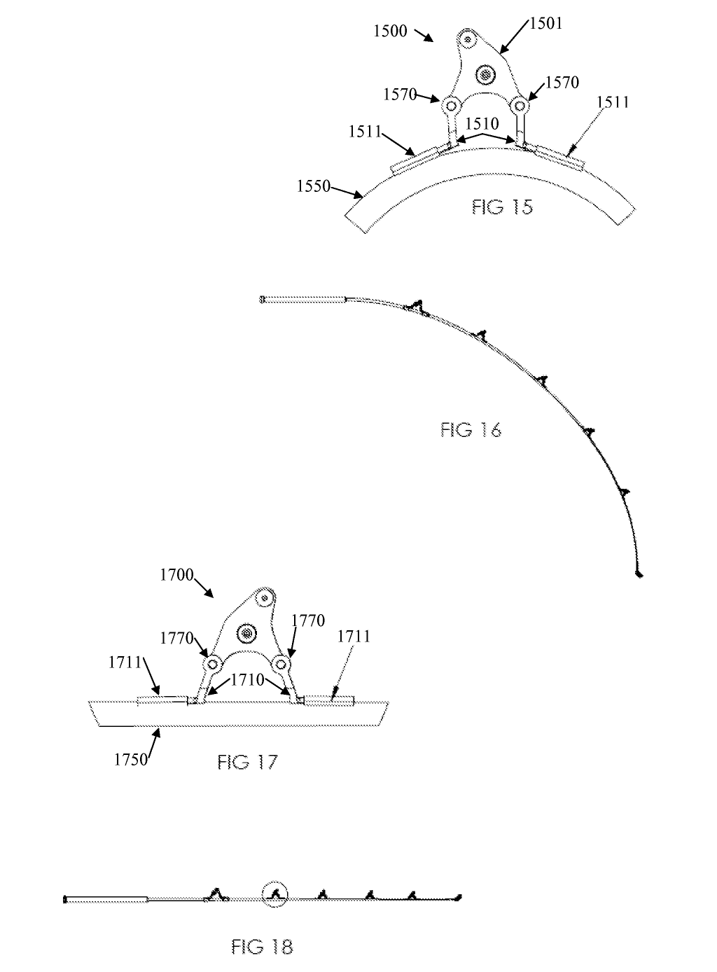

FIG. 18 is a reference side view of a rod with the five line guides placed on the rod and the rod is in a normal relaxed position.

Again, as stated earlier, the legs of the roller guide pivot with the rod as the rod bends which allows the rod to bend more true to form during use. The presence, and proper placement through calibration based on the specific rod, of pivots and slides, allows the guide construction to accommodate the flex of the rod.

There are usually four to six guides on a fishing rod depending on the length of the rod. The rear guide (closest to the fishing reel) is the largest, about 5 inches in length toe to toe, about 2½ inches in height and about ½ inch wide; the smallest guide at the tip of the rod is about 4 inches long, 2 inches high and ½ inch wide. Although each guide's proportions normally decrease a small amount in size as they get closer to the tip of the rod, sometimes the use of two or more of the same size guides on the same rod is possible.

Again, by allowing the legs to flex while bending reduces the flat spots in the rod which in turn improves the strength of the rod by reducing the stress that a rigid guide induces. Thus, the flexible guide reduces rod fractures and broken rods. The flex during use provides a more realistic and natural feel in the rod during use. Additionally, the flexible roller guide disclosed herein enables one of ordinary skill to repair or replace a guide in the field rather than discarding the rod or having it professionally repaired. This is because the disclosed guides can be disassembled, for example, with a hex key at any time by simply pushing out the pins, thus allowing the removal of the guide for either cleaning the existing roller parts or replacing with spare parts Thus, maintenance and repair is allowed at any time as opposed the current roller guides that have solid frames permanently bonded to the rod and can only be removed by a professional.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

For means-plus-function limitations, if any, recited in the claims, the means are not intended to be limited to the means disclosed in this application for performing the recited function, but are intended to cover in scope any means, known now or later developed, for performing the recited function.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and /or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A roller guide for fishing rod, the roller guide comprising a frame associated with which are two feet for associating the frame to the fishing rod during installation of the roller guide onto the fishing rod, wherein at least one of the two feet is pivotally associated at one end with the frame, such that when the roller guide is installed onto the fishing rod, the at least one of the two feet pivots with the fishing rod when the fishing rod bends, thus, accommodating the flex of the fishing rod during use.

2. The roller guide of claim 1, wherein both of the two feet are pivotally associated at one end with the frame to further accommodate the flex of the fishing rod during use.

3. The roller guide of claim 2, wherein the pivotal association is accomplished by using a hinge, one for each foot, to join the two feet with the frame.

4. The roller guide of claim 2, wherein the installation of the roller guide onto the fishing rod can be accomplished by bonding the other end of each of the two feet to the fishing rod.

5. The roller guide of claim 1, further comprising a sock sliding over one of the two feet, such that the installation of the roller guide onto the fishing rod can be accomplished by bonding the sock, and the other foot without a sock, to the fishing rod, such that the foot with the sock can slide in-and-out of the sock to further accommodate the flex of the fishing rod during use.

6. The roller guide of claim 1, further comprising two sliding socks, one over each of the two feet, such that the installation of the roller guide onto the fishing rod can be accomplished by bonding the two socks to the fishing rod, such that each of the two feet can slide in-and-out of its sock to further accommodate the flex of the fishing rod during use.

7. A fishing rod comprising a plurality of roller guides, wherein at least one of the plurality of roller guides comprises a frame associated with which are two feet for associating the frame to the fishing rod during installation of the at least one of the plurality of roller guides onto the fishing rod, wherein at least one of the two feet is pivotally associated at one end with the frame, such that when the at least one of the plurality of roller guides is installed onto the fishing rod, the at least one of the two feet pivots with the fishing rod when the fishing rod bends, thus, accommodating the flex of the fishing rod during use.

8. The fishing rod of claim 7, wherein both of the two feet are pivotally associated at one end with the frame to further accommodate the flex of the fishing rod during use.

9. The fishing rod of claim 8, wherein the pivotal association is accomplished by using a hinge, one for each foot, to join the two feet with the frame.

10. The fishing rod of claim 8, wherein the installation of the at least one of the plurality of roller guides onto the fishing rod can be accomplished by bonding the other end of each of the two feet to the fishing rod.

11. The fishing rod of claim 7, further comprising a sock sliding over one of the two feet, such that the installation of the at least one of the plurality of roller guides onto the fishing rod can be accomplished by bonding the sock, and the other foot without a sock, to the fishing rod, such that the foot with the sock can slide in-and-out of the sock to further accommodate the flex of the fishing rod during use.

12. The fishing rod of claim 7, further comprising two sliding socks, one over each of the two feet, such that the installation of the at least one of the plurality of roller guides onto the fishing rod can be accomplished by bonding the two socks to the fishing rod, such that each of the two feet can slide in-and-out of its sock to further accommodate the flex of the fishing rod during use.

13. The fishing rod of claim 12 comprising five roller guides gradually decreasing in size from the reel end of the fishing rod to the tip end of the fishing rod.

14. The fishing rod of claim 13, wherein the two roller guides closest to the reel of the fishing rod have socks while the remaining three roller guides do not.

15. The fishing rod of claim 13, wherein all five roller guides have socks.
